(19) United States
(12) Patent Application Publication
(10) Pub. No.: US 2005/0278232 A1
(43) Pub. Date: Dec. 15, 2005

(54) Invoice transaction lifecycle software

(76) Inventors: Brian E. Bruffey, Mt. Airy, MD (US); Frank S. Bruffey JR., Rehobeth Beach, DE (US); Frank S. Bruffey III, Ellicott City, MD (US)

Correspondence Address: LITMAN LAW OFFICES, LTD, PO BOX 15035, CRYSTAL CITY STATION, ARLINGTON, VA, 22215, US

(21) Appl. No.: 10/864,489

(22) Filed: Jun. 10, 2004

(51) Int. Cl. G06F 17/60

(52) U.S. Cl. 705/30

(57) ABSTRACT

The invoice transaction lifecycle software is a snap-in for a customer relationship management (CRM) software package that includes full invoice transaction lifecycle processing, allowing customer request initiation, fulfillment, accounting, and completion to be performed through a common single user interface. The invoice transaction lifecycle software employs a program and database architecture to modify a conventional CRM architecture to include extended invoice transaction functions. In the preferred embodiment, a Microsoft CRM product is enhanced by modification of native database tables, addition of new database tables, and addition of software processes to support the complete invoice transaction lifecycle including invoice generation, product selection and pricing, order fulfillment, and payment and accounting activities.

### BACKGROUND OF THE INVENTION

1. Field of the Invention

The present invention relates to computer software systems for customer relationship management, and more specifically to invoice transaction lifecycle software comprising a customer relationship management program having invoice transaction lifecycle support functions to provide centralized, full-lifecycle invoice transaction business logic for managing all transaction relating to a particular customer invoice.

2. Description of the Related Art

Businesses and organizations use computer systems to track customer transactions, maintaining a database of past and present customer transactions and their status. While the transaction itself is often executed by disparate organizations, including both various divisions of the business itself and outside vendors, information relating to the customer, and the history and status of the customer's current transaction, is often centrally maintained by the business and updated as the current transaction progresses. Customer Relationship Management (CRM) systems facilitate tracking of customer transactions and their history, as well as additional information about the customer, providing a full “360 degree” view of customer information. A “360 degree view” refers to the ability to access all information relating to a customer from a single point.

In practice, while such systems provide excellent capability for maintaining a customer database, and for providing ready information regarding the status of customer transactions and issues, such systems are disconnected from the execution of the transaction itself. Referring to FIG. 2, a typical business system architecture is illustrated wherein a business maintains a centralized database 902 that provides a customer service department 900 with a complete customer data view. Disparate divisions or outside vendors 904, each maintain their own transaction system including business logic 906, local database 908, and data views 910 to fulfill their own roles in the transaction process, from sales to service to accounting. These divisions or outside vendors 904 communicate with the business's centralized database 902 to update customer information, creating redundancies between the divisions or outside vendor database 908 and the centralized database 902. The database structure is optimized toward importing data from, and exporting data to, divisions or outside vendors 904. Such an approach requires the use of sophisticated and complex middleware software to maintain synchronization and redundancy between databases.

In a typical scenario, a business performs marketing and sales activities that culminate when a customer places an order for goods or services. The customer's order is recorded in the business's customer database 902. However, to fulfill the customer's order, the order must be dispatched to the appropriate division or outside vendor 904 for fulfillment. While a division or outside vendor 904 may communicate with the business's customer database to provide status updates as the order progresses, processing of the order generally involves separate procedures, and separate computer software systems, using the division's or outside vendor's 904 business logic 906, database 908, and data views 910 to fulfill the order. Further, a sales order is often completed by a separate business division or outside vendor 904 using a back-office financial accounting system. As the transaction progresses, the business's centralized database 902 is provided with status updates by the division or outside vendor 904. Additionally, as the transaction progresses, and customer data from the business's centralized database 902 is needed by the legacy processes of the division or outside vendor 904, the data must be exported from the business's centralized database 902. Information is duplicated, creating redundancies between the division or outside vendor database 908 and the business's centralized database 902.

With the growth of information technology (IT), and specifically the growth of distributed and networked software systems and the Internet, great strides have been made in improving communications between computer software systems and, as a result, between business divisions and outside vendors. An early technology, designed to facilitate exchange of electronic documents, is Electronic Data Interchange or EDI. Historically EDI has been an expensive solution that often requires a large investment in software development to customize, or provide customized interfaces to, existing legacy systems. It can be recognized that, in a business system architecture, such as the architecture depicted in FIG. 2, the cost of an EDI solution increases with the number of disparate divisions or outside vendors 904 that each need a customized interface.

U.S. Pat. No. 6,507,826, issued on Jan. 14, 2003 to G. Maners, discloses a remote electronic invoice entry and validation system. The '826 patent describes the use of EDI and its shortcomings in exchanging documents, such as invoices, among companies, and proposes an invoice processing server that is accessible by a standard network or Internet client, such as a computer operating with a standard web browser application. While this centralized invoice server provides a capability for vendors to interact with a business's invoicing system, it lacks connectivity to the business's customer relationship management databases.

U.S. Pat. No. 6,304,857, issued on Oct. 16, 2001 to D. Heindel et al., discloses an electronic billing system wherein a number of billing organizations are provided with a billing integration system that integrates with the billers' legacy billing systems to translate electronic billing documents into a form that is compatible with a billing service center system.

U.S. patent Publication No. 2002/0038305, published on Mar. 28, 2002, discloses an automated invoice receipt and management system that can accept invoices from a plurality of suppliers using a plurality of electronic formats. Invoices are managed, normalized, and provided to customers in a form that is compatible with the customers' systems for electronic data entry.

Local area network (LAN) and Internet enabled CRM computer programs allow a centralized CRM server to be accessed by numerous clients, using standard data formats and protocols to allow access by standard client applications, such as a standard web browser. One such CRM program is the Microsoft® Customer Relationship Management (MS-CRM) software product, e.g., as described in a Microsoft Customer Relationship Management brochure published in 2002 by the Microsoft Corporation.

The MS-CRM employs a software architecture and program logic providing a common, single-user interface that gives users an extensive view of customer data and allows users to initiate actions resulting in follow-up action in response to customer requests. For example, a customer service representative determines the status of an order and communicates the status to a customer in response to a customer's inquiry about the status of an order. A customer may request technical assistance, or may request to purchase a product. Beyond entry of a request, however, fulfillment of the request is limited. A transaction may be initiated by MS-CRM, but completion relies on disparate software applications. For example, a sales order can be initiated in MS-CRM but must be completed with a separate back-office financial accounting program. Thus, a complete enterprise system architecture based on the MS-CRM typically relies on multiple separate applications that support an organization's core business activities related to sales, service, and accounting, each having a different user interface.

The MS-CRM database structure relies on importing data from, and exporting data to, the multiple separate applications in order to provide the MS-CRM with views of that data. This structure requires the use of sophisticated and complex middleware to maintain synchronization and redundancy of databases. The use of complex middleware requires a high level skill set for development and maintenance, increasing the cost of changing or updating business applications. Additionally, the need to configure and maintain multiple database tables makes implementation of the MS-CRM software unduly complicated.

None of the above inventions and patents, taken either singly or in combination, is seen to describe the instant invention as claimed. Thus, the invoice transaction lifecycle software of the present invention solving the aforementioned problems is desired.

### SUMMARY OF THE INVENTION

The invoice transaction lifecycle software is a customer relationship management (CRM) software package that includes full invoice transaction lifecycle processing, allowing customer request initiation, fulfillment, accounting, and completion to be performed through a common single user interface. The invoice transaction lifecycle software of the present invention may be furnished as a “snap-in” or plug-in aftermarket module or series of modules that integrates with an existing CRM program, or may be concurrently marketed with the CRM program for concurrent installation.

The invoice transaction lifecycle software employs a program and database architecture to modify a traditional or existing CRM architecture to include extended invoice transaction functions. In the preferred embodiment, the MS-CRM product is enhanced by modification of its native database tables, addition of new database tables, and addition of software processes to support the complete invoice transaction lifecycle.

The invoice transaction lifecycle software utilizes a database structure and program logic that minimizes the need to import and export data between the CRM database and other business process software by incorporating business logic that traditionally has been performed by separate legacy software products. Redundant “master” and “transaction” database tables are replaced by the single CRM database. As a result, the requirement for complex middleware to maintain synchronization and redundancy of databases is eliminated. The invoice transaction lifecycle software can be configured for use without a high level IT skill set, decreasing the cost of installation and implementation by businesses.

The Microsoft MS-CRM product is built with .NET technology, and provides user interface views that allow interaction with a customer database from a desktop, or a networked or World Wide Web (Web) client. Thus, a businesses' employees, customers, and vendors may be given access to all or part of the customer database. The MS-CRM product includes a software development kit (SDK) that allows developers to make modifications to native MS-CRM database tables, user interface views, and program processes in a manner that is non-intrusive to, and compatible with, native MS-CRM program logic and future upgrades.

The MS-CRM SDK consists of development tools to: 1) access existing, native MS-CRM data elements; 2) add additional data elements to native MS-CRM data tables; 3) modify native MS-CRM user interface views; 4) create new user interface views; and 5) add additional program processes using .NET software development tools. A computer software product developed with the SDK for the MS-CRM is referred to as a “snap-in” product.

The invoice transaction lifecycle software is developed as a snap-in for the MS-CRM. The invoice transaction lifecycle software provides full lifecycle invoice transaction processing. The invoice transaction lifecycle software functionality allows initiation and completion of invoice transactions within the CRM. Database tables native to the MS-CRM are modified, and new tables created, to support program logic to create quotes, create invoices, track accounts receivable, track inventory, generate and print invoices, apply payments to invoices, and complete the invoice transaction lifecycle by updating general ledger debits and credits, interfacing seamlessly with an external accounting program, such as Microsoft Great Plains, Microsoft Solomon, or other financial software.

These and other features of the present invention will become readily apparent upon further review of the following specification and drawings.

### BRIEF DESCRIPTION OF THE DRAWINGS

FIG. 1 is a block diagram showing the various transactions accounted for in an invoice transaction lifecycle software system according to the present invention.

FIG. 2 is a block diagram of a prior art sales and invoicing system architecture based on a conventional customer relationship management system.

FIG. 3 is a block diagram of an invoice transaction lifecycle software system architecture according to the present invention.

FIG. 4 is a block diagram of a network architecture for the invoice transaction lifecycle software system according to a preferred embodiment of the present invention.

FIG. 5 is a block diagram of a computer system in which the invoice transaction lifestyle software operates according to a preferred embodiment of the present invention.

FIG. 6 is a block diagram depicting major software components of the present invention.

FIG. 7 is a block diagram that maps the stages of an invoice transaction lifecycle to the major software components of the present invention.

FIG. 8 is a flow chart identifying general functions of an invoice transaction lifecycle software system according to the present invention.

FIG. 9 is a block diagram illustrating customization of native Microsoft CRM database tables in a preferred embodiment of the present invention.

FIG. 10 is a block diagram showing added database tables in relation to major software components of the present invention.

FIG. 11 is an entity relationship diagram depicting a database schema for the present invention.

FIG. 12 is a block diagram of a process for creating an invoice header for entry of an order according to the present invention.

FIG. 13 is an entity relationship diagram depicting a database schema for the process of FIG. 12.

FIG. 14 is a screen shot of a web page showing a customer list according to the present invention.

FIG. 15 is a screen shot of a web page showing customer information, and particularly a list of invoices associated with a customer according to the present invention.

FIG. 16 is a screen shot of a web page showing a new customer invoice according to the present invention.

FIG. 17A is a partial screen shot showing an entry form for general information for an invoice header according to the present invention.

FIG. 17B is a partial screen shot showing an entry form for address information for an invoice header according to the present invention.

FIG. 17C is a partial screen shot showing an entry form for administrative information for an invoice header according to the present invention.

FIG. 18 is a screen shot of a web page showing a dialog box for entry of invoice header information from an internal database according to the present invention.

FIG. 19 is the customer list screen shot of FIG. 14 with a button activated for addition of a new transaction to the invoice.

FIG. 20 is a flowchart of a process for adding a transaction detail to an invoice according to the present invention.

FIG. 21 is an entity relationship diagram depicting a database schema for product entry steps of the process of FIG. 20.

FIG. 22 is a screen shot of a web page showing a form for entry of a transaction item information according to the present invention.

FIG. 23 is a screen shot of a web page showing a form for entry of shipping information for a transaction item according to the present invention.

FIG. 24 is an entity relationship diagram depicting a database schema for payment steps of the process of FIG. 19.

FIG. 25 is a screen shot of a web page showing a form for entry of payment information for a transaction item.

FIG. 26 is a screen shot of a web page showing a form for entry of credit card information for a transaction item according to the present invention.

FIG. 27 is a flowchart of a process for posting invoices to an accounting system according to the present invention.

FIG. 28 is a flowchart of a process for creation and management of invoice batches according to the present invention.

FIG. 29 is a screen shot of a web page showing a user interface for selecting batch management a d posting functions according to the present invention.

FIG. 30 is a screen shot of a web page showing a listing of invoice batches according to the present invention.

FIG. 31 is a screen shot of a web page showing a dialog box for entry and manipulation of data relating to an invoice batch according to the present invention.

Similar reference characters denote corresponding features consistently throughout the attached drawings.

### DETAILED DESCRIPTION OF THE PREFERRED EMBODIMENT

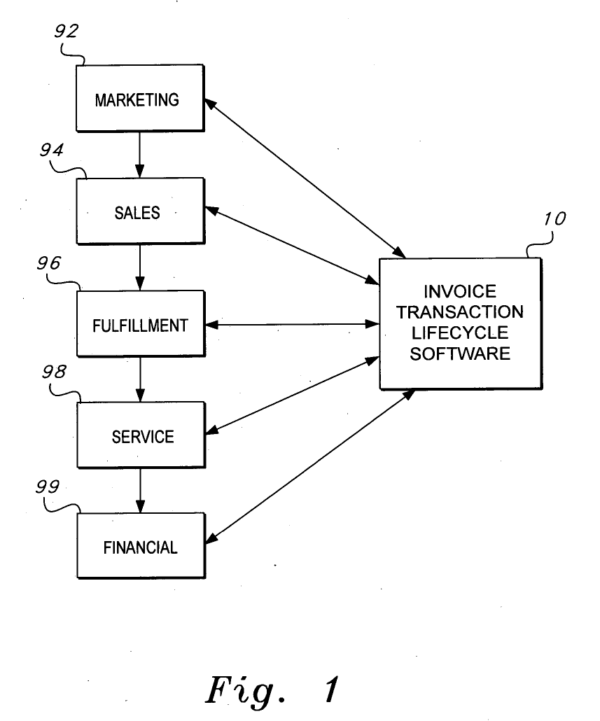

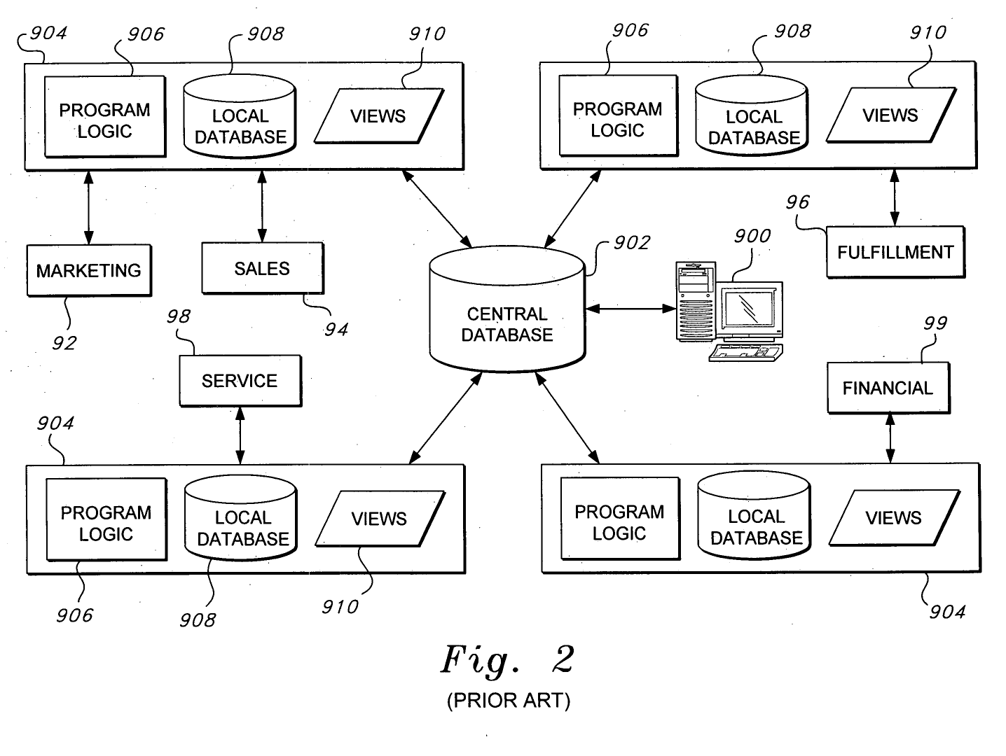

The present invention is invoice transaction lifecycle software that provides full invoice transaction lifecycle business logic and processes within a customer relationship management program environment. An “invoice transaction” generally relates to a customer order for goods or services. Referring to FIG. 1, an invoice transaction typically goes through five (5) stages in an “invoice transaction lifecycle”, each of the stages being characterized by particular activities that are performed. Invoice transaction lifecycle stages are: 1) marketing 92, involving promotion of an organization's products and services to a targeted market; 2) sales 94, involving the active pursuit of sales leads and opportunities; 3) fulfillment 96, when an order is received and products or services are delivered; 4) service 98, including customer follow-up to an order; and 5) financial 99, involving resolution of debits and credits to effect payment for the transaction. The invoice transaction lifecycle software 10 provides support for each stage of the complete invoice transaction lifecycle.

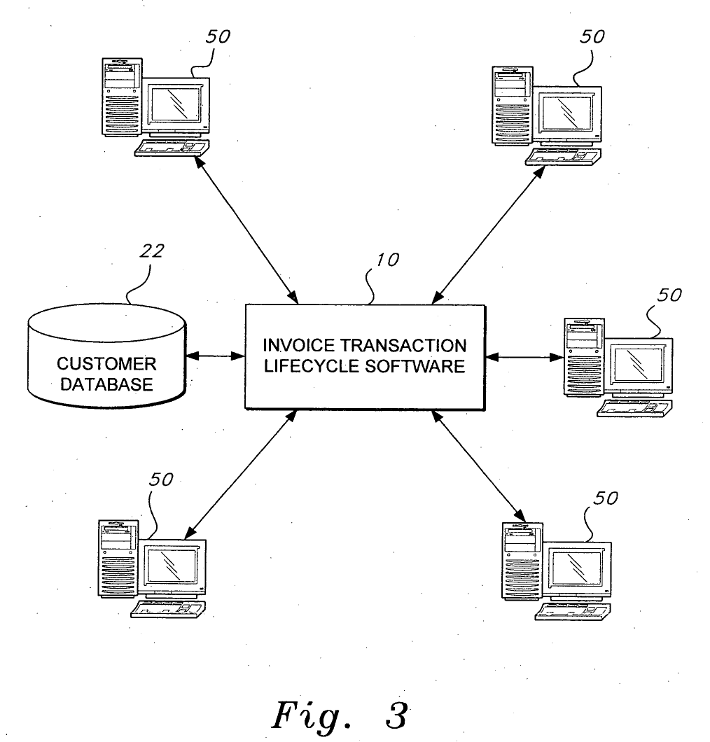

Turning now to FIG. 3, the invoice transaction lifecycle software 10 provides multiple users 50 with centralized access to a customer database 22. Business logic implemented by the invoice transaction lifecycle software 10 is available to each of the users 50, whether divisions of the business or outside vendors, to perform any activity of the invoice transaction lifecycle stages.

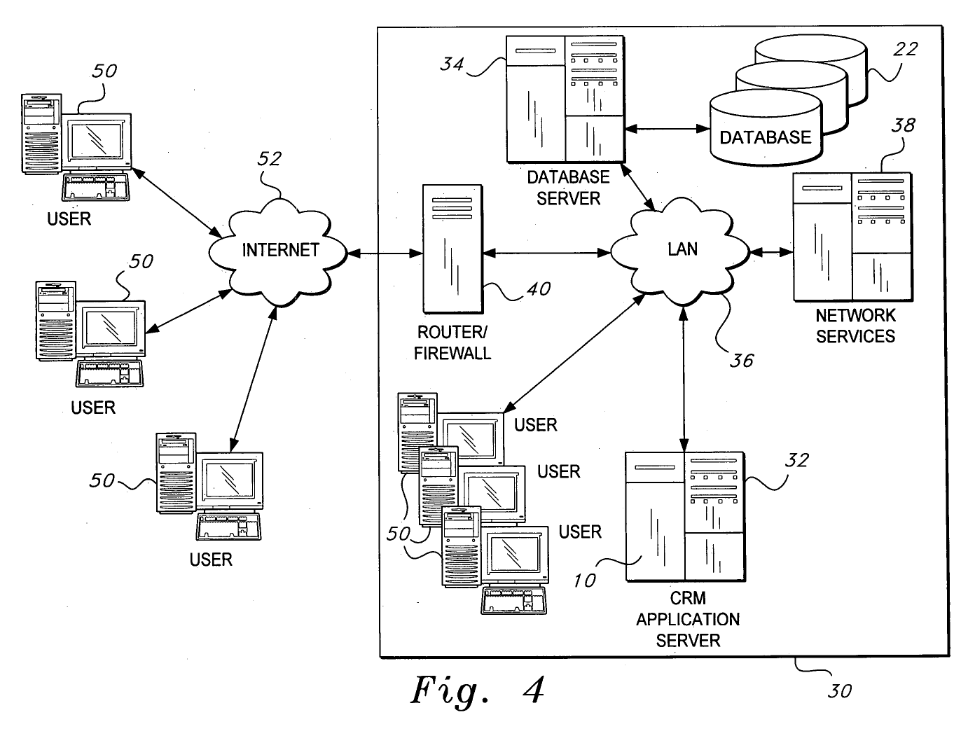

In a preferred embodiment, the invoice transaction lifecycle software 10 is executed on a CRM server 32 in a network environment, shown in FIG. 4. In a typical business enterprise IT architecture 30, multiple servers may be dedicated for particular tasks. As illustrated, for example, a business enterprise 30 includes the CRM server 32 in communication with a LAN 36. A database server 34 is provided to maintain the database 22 tables utilized by the CRM server 32. A network services server 38 may provide additional services to the network environment. Users, utilizing user computers 50, may access the CRM server 32 to use the invoice transaction lifecycle software 10, either by direct connection to the LAN 36, or by an Internet 52 connection that is typically established though a router or firewall 40 for security.

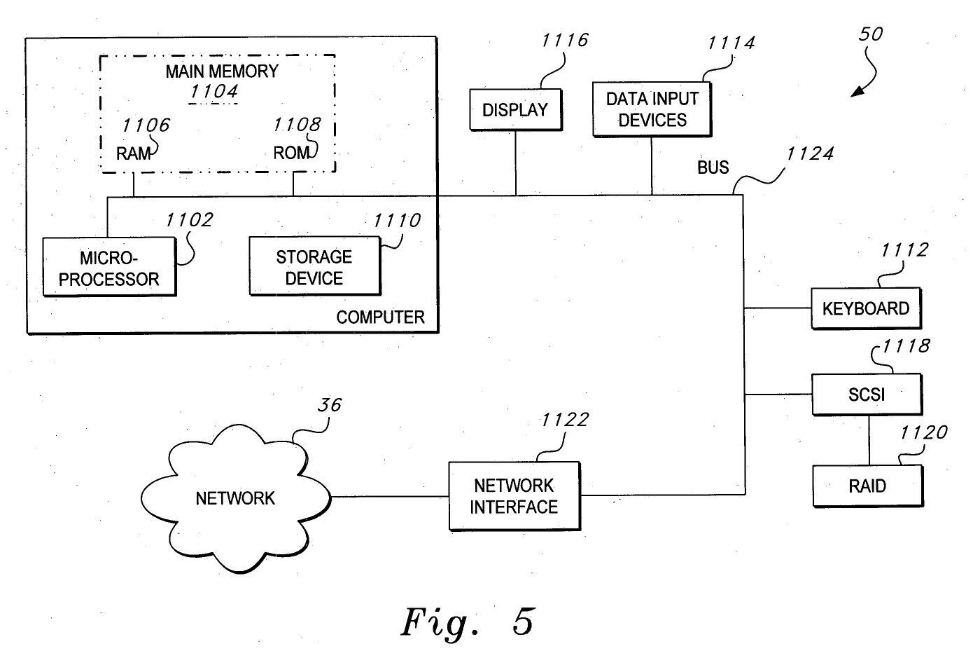

Turning to FIG. 5, the user computers 50 and servers are general purpose or personal computers of a generally known and common configuration. Such a computer has a microprocessor 1102 connected by a bus 1124 to an area of main memory 1104, comprising both read only memory (ROM) 1108, and random access memory (RAM) 1106, and a storage device 1110 having means for reading a coded set of program instructions on a computer readable medium which may be loaded into main memory 1104 and executed by the microprocessor 1102. The computer 1100 has a display device 1116, a keyboard 1112, and may include other input devices 1114 such as a mouse, joystick, etc. A network communication interface 1122 is provided for serial communications on a network or other serial communications link. Additionally, the computer 1100 may include a Small Computer System Interface (SCSI) adapter 1118 for communication with peripheral devices, such as a Redundant Array of Independent Disks (RAID) 1120 for mass data storage.

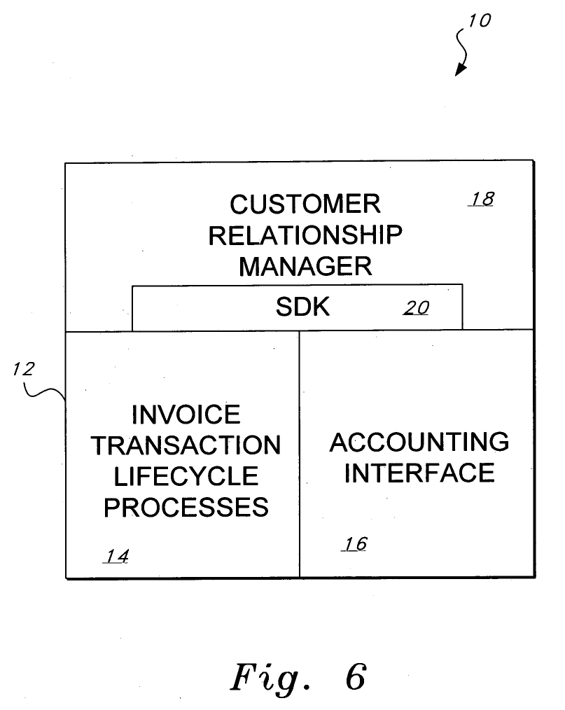

Turning now to FIG. 6, in a preferred embodiment the invoice transaction lifecycle software 10 is based on an invoice transaction lifecycle snap-in component 12 modifying and enhancing a commercially available customer relationship management (CRM) product 18, specifically, Microsoft's Customer Relationship Management product (CRM). The invoice transaction lifecycle snap-in component 12 provides invoice transaction lifecycle processes 14, and an accounting interface 16 for interaction with an external accounting software package.

A software development kit (SDK) 20 component of the CRM 18, provided by Microsoft, consists of development tools utilized by the present invention to; 1) access existing, native MS-CRM data elements; 2) modify native MS-CRM database schema by adding additional data elements to native MS-CRM data tables; 3) modify the native MS-CRM database schema by adding additional data tables; 4) modify native MS-CRM user interface views; 5) create new user interface views; and 6) add additional program processes using .NET software development tools.

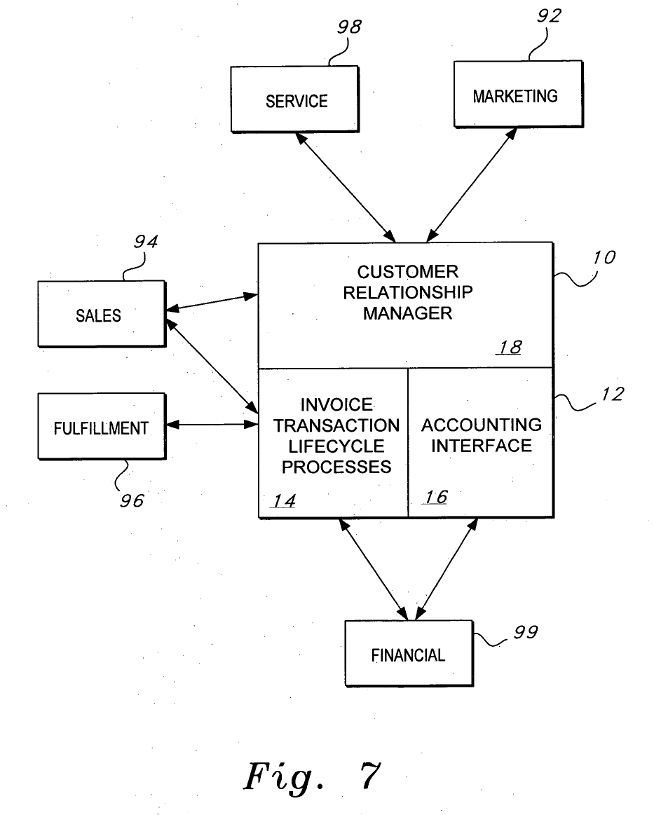

Referring to FIG. 7, it can be seen that the invoice transaction lifecycle stages are supported in part by the native CRM 18, in part by the invoice transaction lifecycle processes 14, and in part by the accounting interface 16. Marketing 92 and service 98 activities are supported primarily by the processes of the native CRM 18. Sales 94 activities are supported in part by the processes of the CRM 18 and in part by the invoice transaction lifecycle processes 14, while order fulfillment 96 activities are supported primarily by the invoice transaction lifecycle processes 14. Financial activities 99 are supported in part by the invoice transaction lifecycle processes 14 and in part by the accounting interface 16.

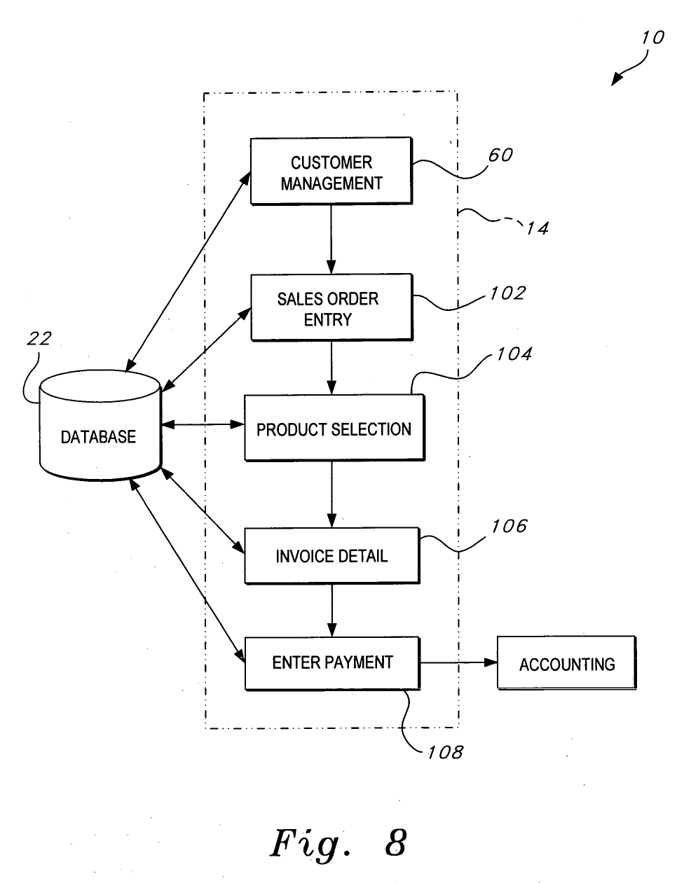

Turning to FIG. 8, the invoice transaction lifecycle software 10 comprises computer program and database components providing support for invoice transaction lifecycle stages, including customer management processes 60 that are typical of a customer relationship management program, along with additional invoice transaction lifecycle processes 14 supporting tasks is related to the complete invoice transaction lifecycle. These invoice transaction lifecycle processes 14 include, broadly, sales order entry 102, product selection 104, invoice detail 106, and invoice processing/accounting 108. Each of these processes is supported by direct access to a database 22, so that throughout the invoice transaction lifecycle information is accessed from, and updated to, the database 22 without the need for complex middleware interfaces between separate computer programs.

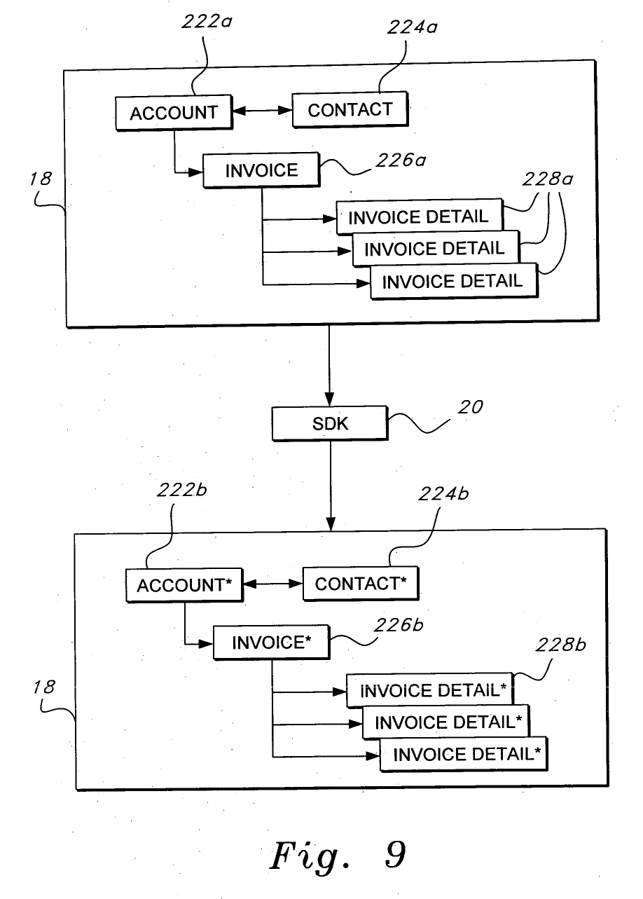

Turning now to FIG. 9, the CRM 18 includes several native data tables, including an account table 222a, a contacts table 224a, an invoice table 226a, and invoice detail tables 228a. The SDK 20 is used to modify these native data tables by adding new items that are used by the invoice transaction lifecycle snap-in 12. Thus, new account table items 222b, new contact table items 224b, new invoice table items 226b, and new invoice detail tables items 228b are used by both the native CRM 18 processes and invoice transaction lifecycle snap-in 12 processes, together with the native data tables.

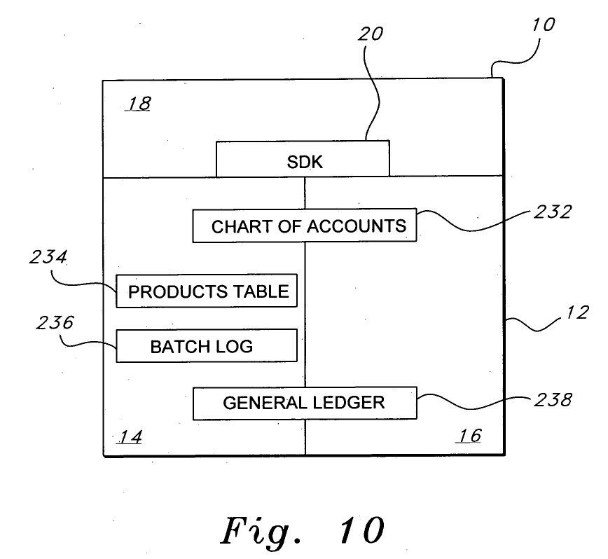

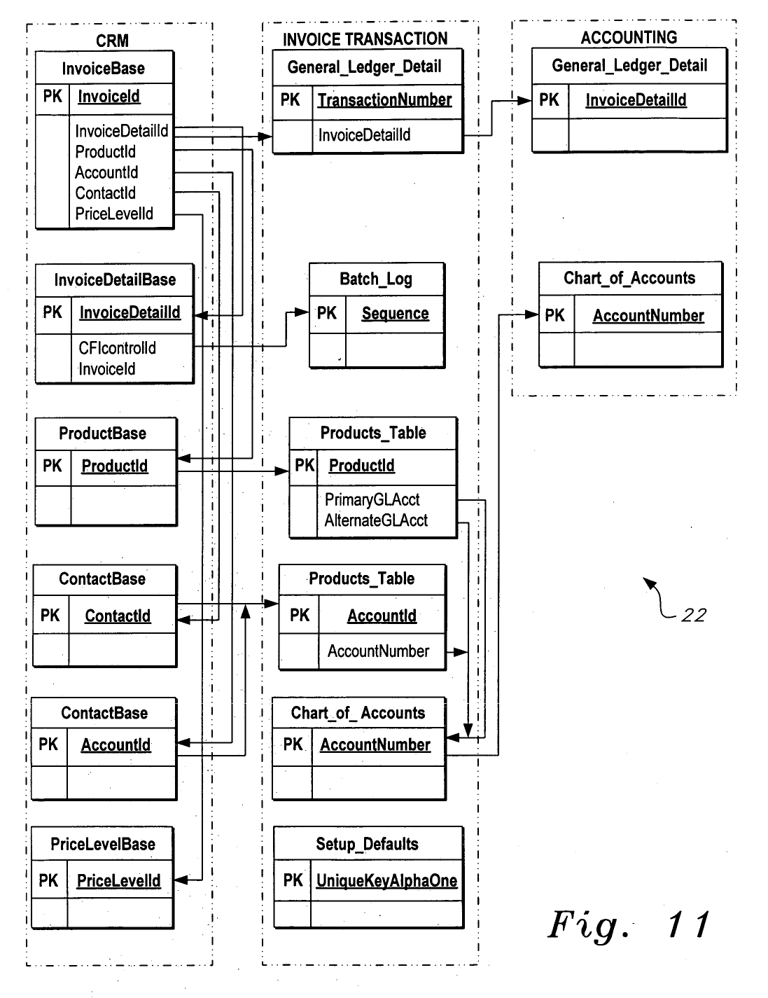

In addition to modifying native CRM data tables, the SDK 20, or strictly speaking, software routines packaged as part of the invoice transaction lifestyle software that were developed using the SDK 20 and run during installation of the snap-in 12, is used to create additional data tables for the invoice transaction lifecycle processes 14 and accounting interface 16. As shown in FIG. 10, a chart of accounts table 232, a products table 234, an invoice batch log table 236, and a general ledger table 238 are added to support the invoice transaction lifecycle snap-in 12. Thus, the database 22 for the invoice transaction lifecycle software 10 comprises the native account table 222a, native contacts table 224a, native invoice table 226a, and native invoice detail tables 228a of the CRM, as modified to include the added new account table items 222b, new contact table items 224b, new invoice table items 226b, and new invoice detail tables items 228b, as well as the new tables, including the additional chart of accounts table 232, products table 234, invoice batch log table 236, and general ledger table 238. The resulting database schema is shown generally in FIG. 11.

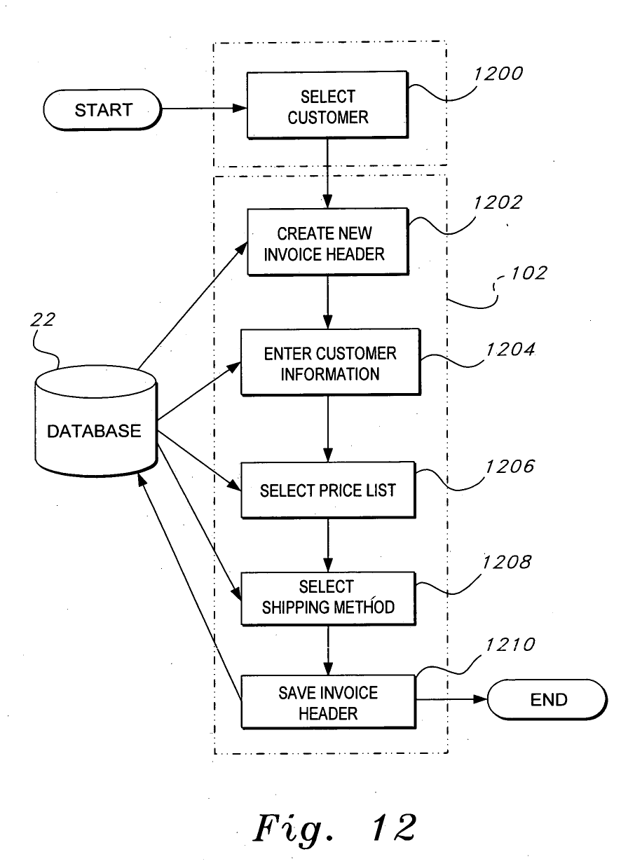

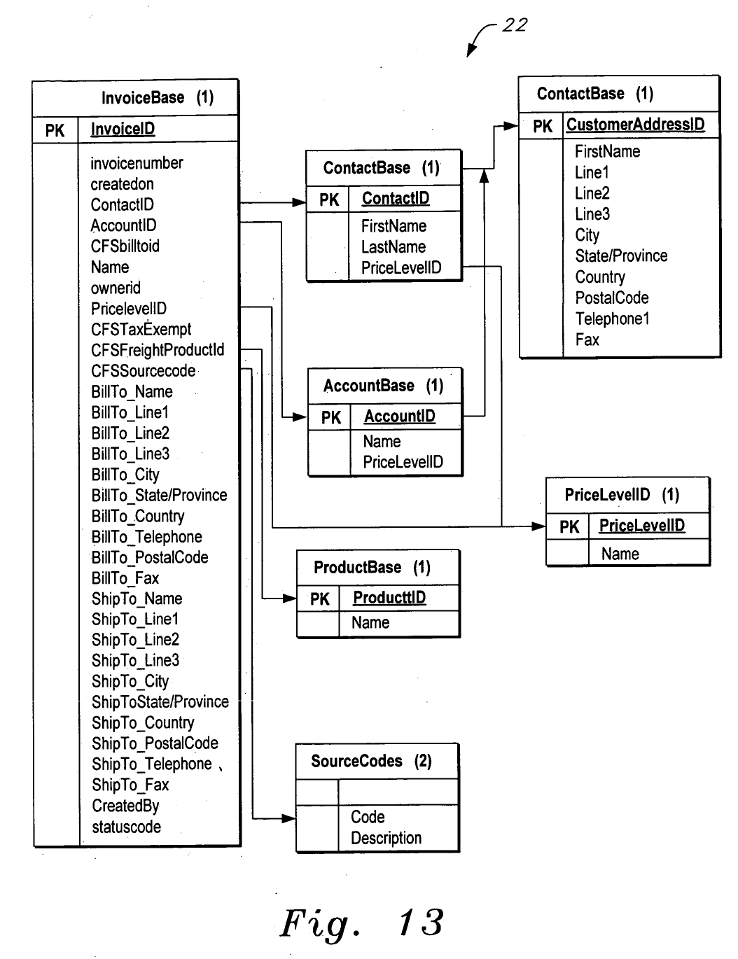

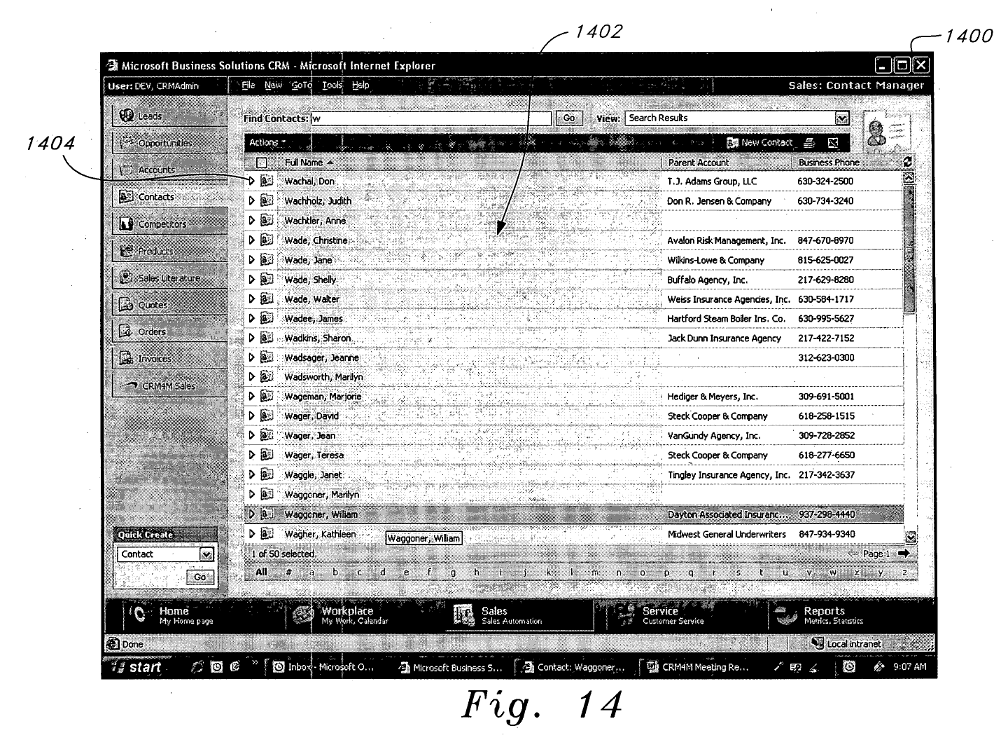

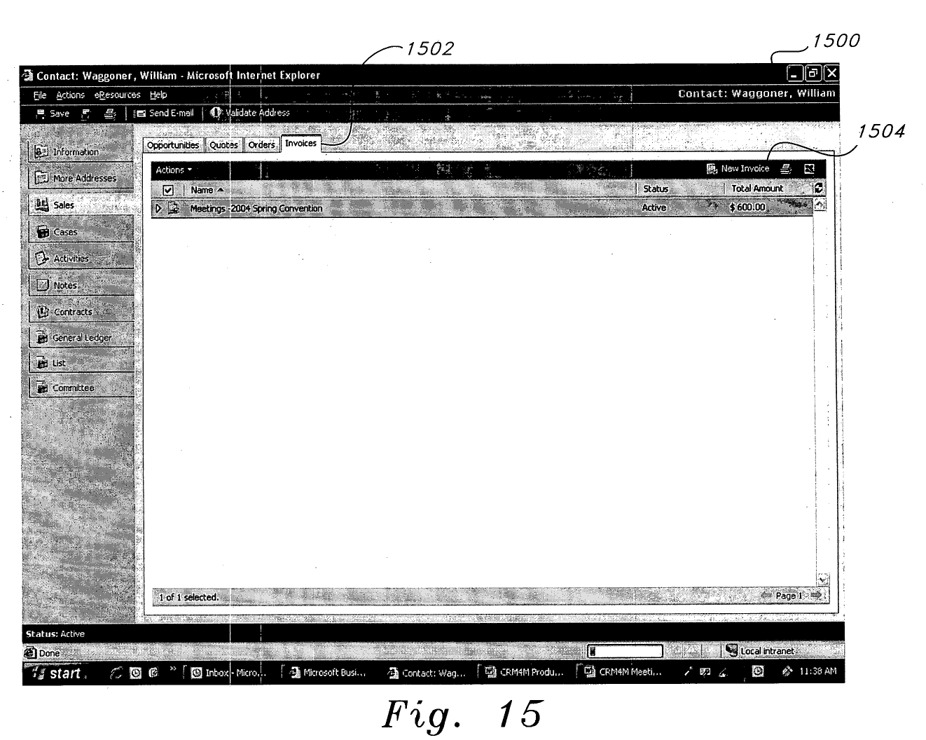

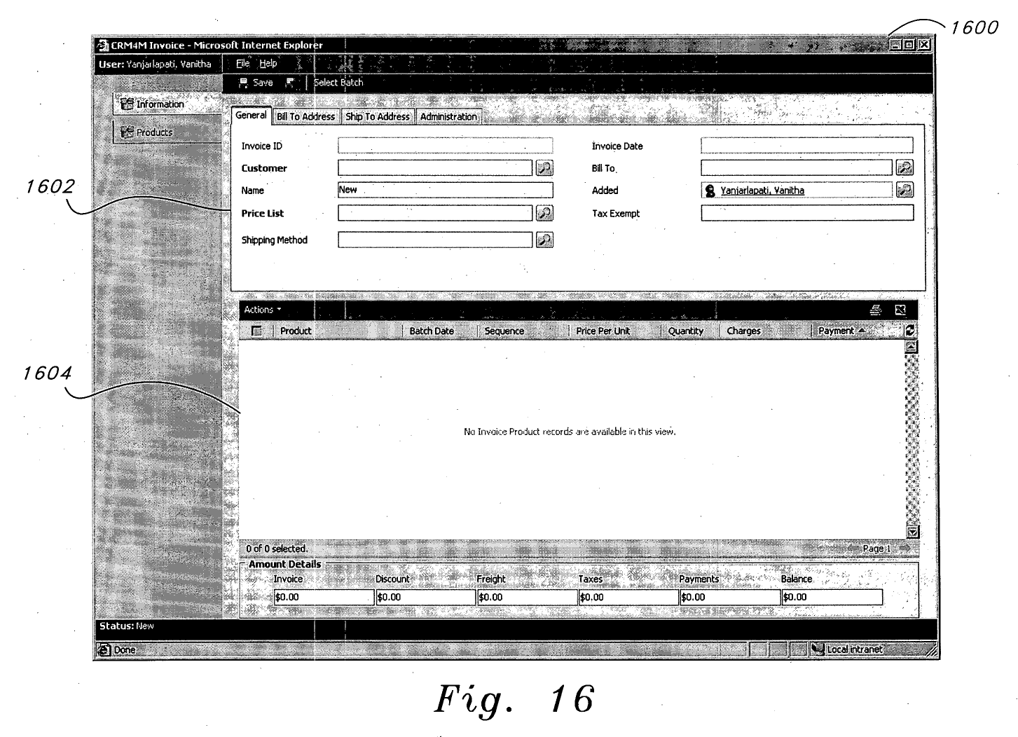

Computer program components of the invoice transaction lifecycle snap-in 12 are developed using, along with the SDK 20, .NET development tools and technology, as well as SQL and C++ and C#, along with other, programming tools. Turning now to FIGS. 12 to 19, the sales order entry process 102 is described. FIG. 12 is a flowchart illustrating the sales order entry process. FIG. 13 illustrates database tables related to the sales order entry process in greater detail. The sales order entry process 102 is generally synonymous with creating and populating a new invoice header. Beginning, at step 1200, with customer management processes and user interface views native to the CRM, a user navigates to a customer list page 1400, seen in FIG. 14, that displays a list 1402 of customers in the database (the names and phone numbers shown in FIG. 14 are fictional, being used for purposes of illustration only). Selecting a customer entry 1404 from the list 1402 opens a customer information page 1500, seen in FIG. 15, which includes an invoice list 1502 listing invoices related to the customer. At step 1202, a “new invoice” control element 1504 on the customer information view 1500 is used to create a new invoice, the invoice comprising an invoice header and invoice item details. Creating the new invoice opens a new invoice page 1600, seen in FIG. 16. The invoice view 1600 includes an invoice header area 1602, for entry of customer information, and an invoice product area 1604 where invoice products are listed as transaction line items. For a new invoice, the invoice product area 1604 is empty.

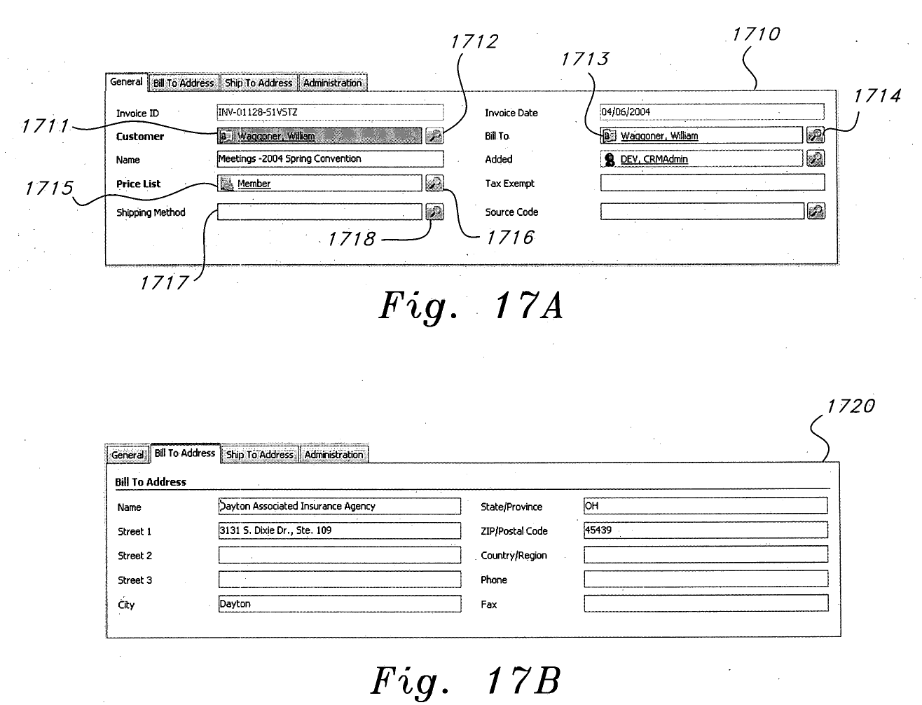

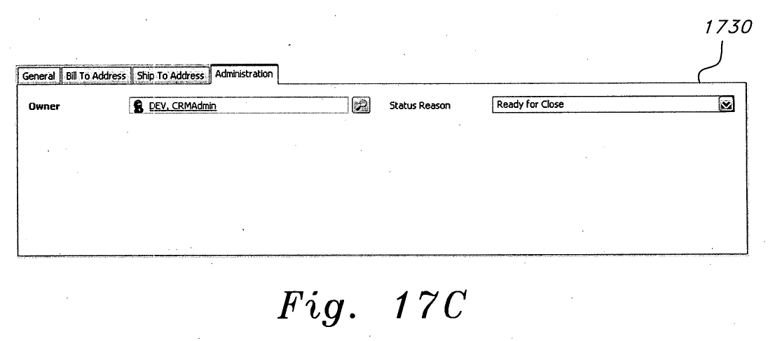

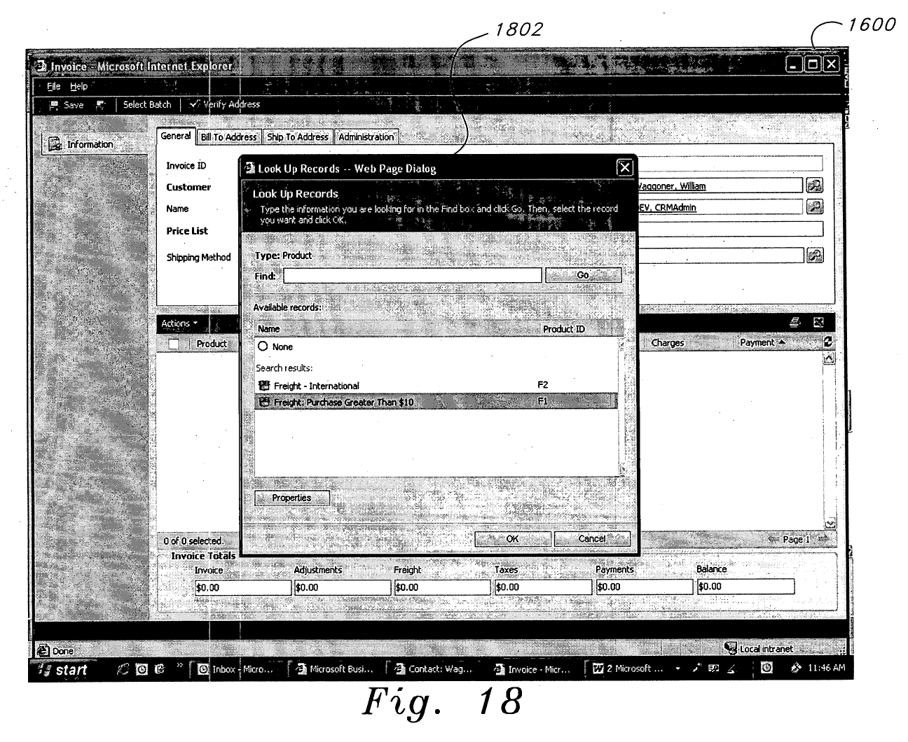

With the new invoice created, the invoice header area 1602 of the invoice view is populated with information about the customer, and information relating to the transaction. In the present embodiment, the invoice header area 1602 of the invoice view 1600 comprises data entry fields for the header information arranged as separate tab views within the invoice header area. It can be appreciated that the arrangement of these data entry screen views is somewhat arbitrary and a matter of design choice. At step 1204, customer information is entered using the general information tab of FIG. 16. A representative completed general information form 1710 is shown in FIG. 17A. Given that navigation to this point has proceeded from a previous customer selection activity (at step 1200), much customer information can be retrieved from the database 22 as “default” information within the invoice view 1600 describing the present customer. A customer field 1711 defaults to the customer's name, as retrieved from the database 22. Alternatively, the customer field 1711 may be manually filled, or may be filled by selecting a customer lookup button 1712 to open a dialog box to retrieve a customer name from the database 22. It can be understood that alternate navigation paths to the invoice view 1600 may be followed so that, for example, an invoice might be created for a new customer not yet recorded in the database 22, and the customer information entered here for the first time. A “bill to” field 1713 defaults to the customer name, although this may be changed by manually entering an alternate name or by using a bill-to lookup button 1714 to open a dialog box to retrieve an alternate bill-to name from the database 22.

In addition to basic customer information, a price list for the customer is selected at step 1206. Different price lists may reflect, for example, members of an organization or a “preferred customer” categorization or the like who are given preferential pricing for goods or services. A price list entry field 1715 defaults to a price list defined for the customer entry in the database 22. Alternatively, a price list for the current invoice may be selected using a price list lookup button 1716 to open a dialog box for price list selection.

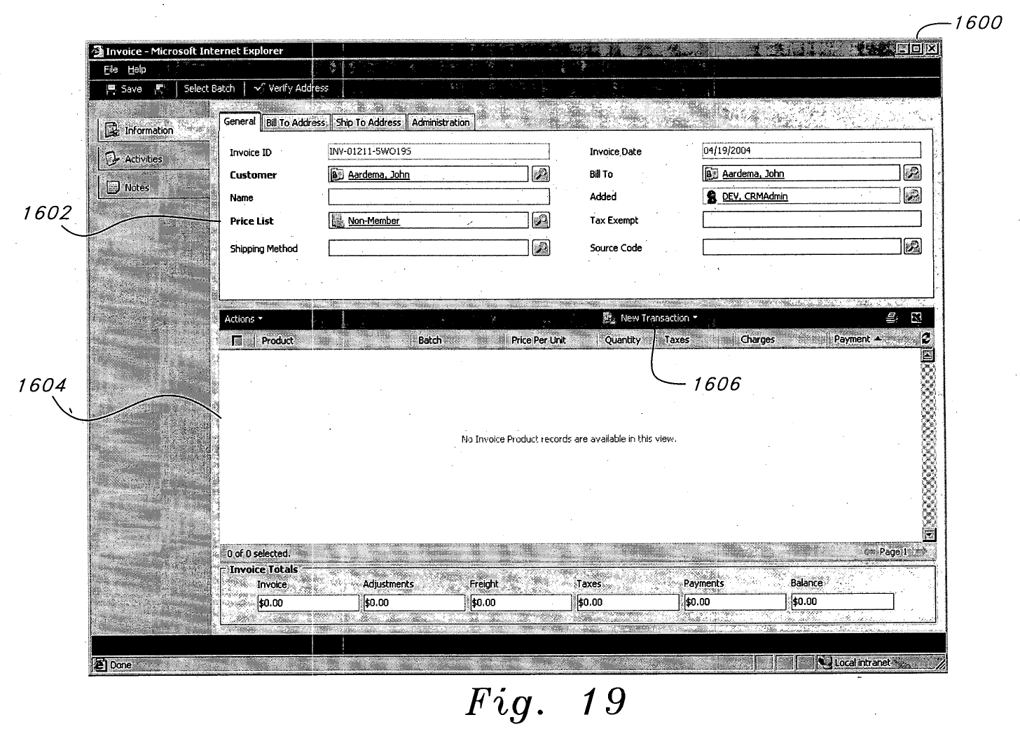

A shipping method for the invoice items may be selected at step 1208. A shipping method field 1717 is blank by default, requiring entry of a shipping method. If a shipping method code is known, it may be entered directly into the shipping method field 1717. Alternatively, a shipping method lookup button 1718 opens a dialog box 1802, shown in FIG. 18, for selection of a shipping method code.

Additional customer information tab views allow entry of additional customer and administrative information. A “bill to address” tab view 1720, shown in FIG. 17B, allows entry of a billing address the invoice. Typically, this defaults to the customer's address. Additionally, a “ship to address” tab view (not shown) allows entry of a shipping address for the invoice. Again, this defaults to the customer's address, but may be overridden. Finally, an administrative information tab view 1730, shown in FIG. 17C, allows entry of administrative information related to the current invoice, such as a salesperson name or identifier, department code, order status, or such. The invoice header is saved at step 1210.

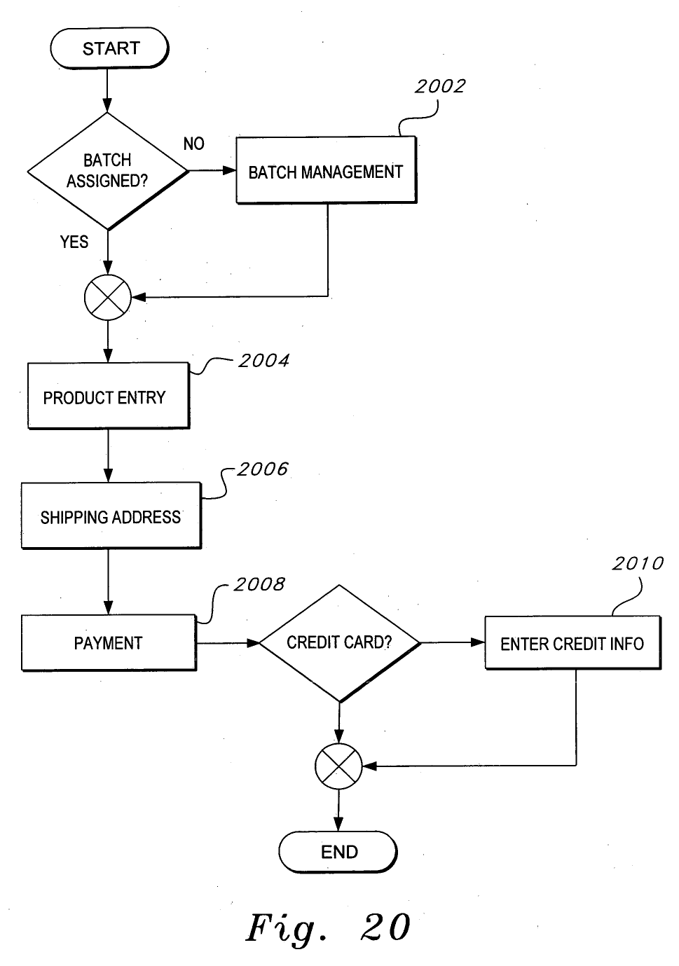

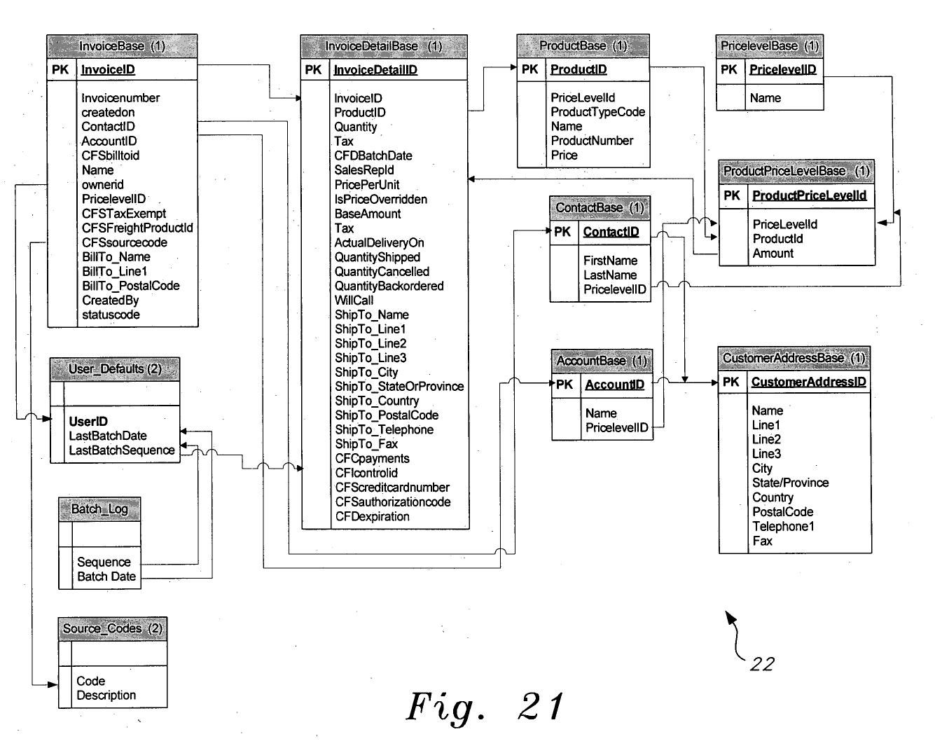

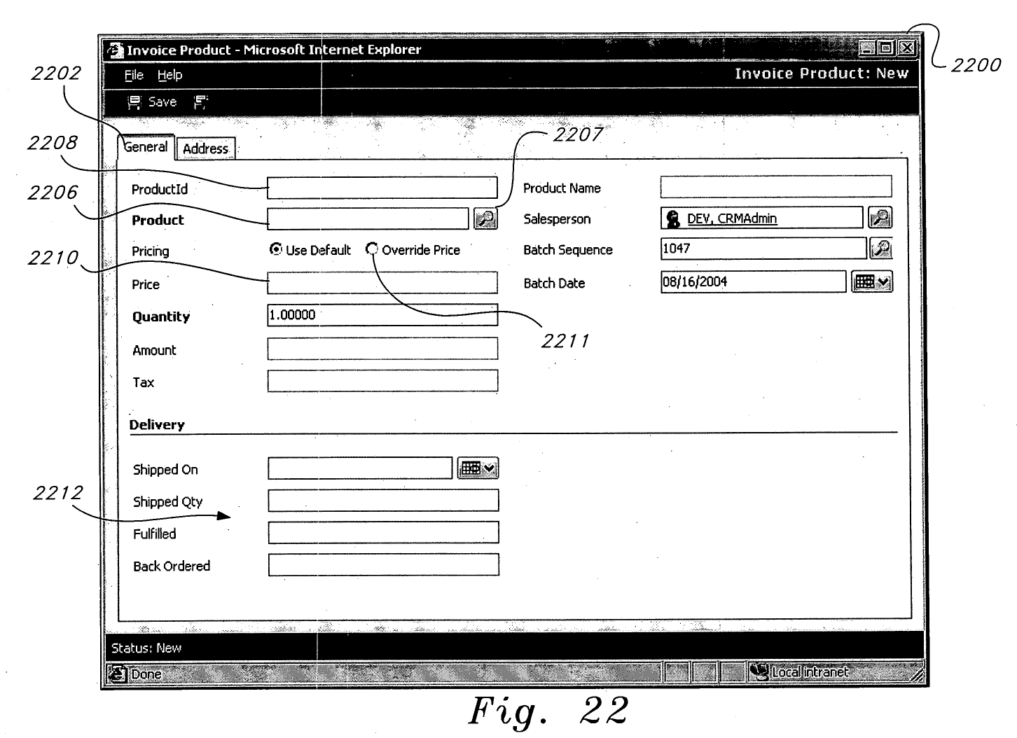

Turning now to FIG. 19, the invoice page 1600 is seen following completion of the invoice header. At this point, a “New Transaction” control 1606 is activated on the invoice view 1600. Transaction line items, generally reflecting the purchase or payment for goods or services, are added to the invoice view 1600 using the new transaction control 1606. A process for adding a new transaction line item is illustrated in FIG. 20. FIG. 21 shows a detailed schema of the database tables related to the transaction line item entry.

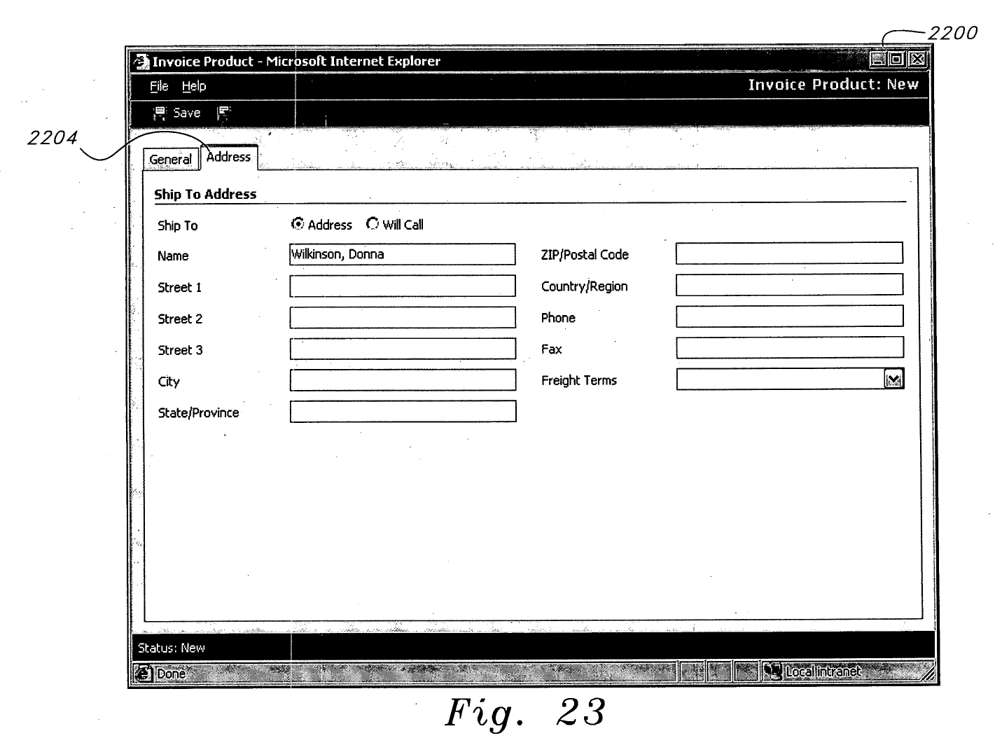

Before a new transaction line item may be added to an invoice, the invoice must be associated with an invoice batch for proper accounting of the invoice. At step 2002, if no batch has been assigned, a batch management process is invoked to assign a batch from a currently open batch, or to create and assign a new batch. Once the invoice has been associated with a batch, a product is selected, at step 2004. A product screen 2200 is seen in FIG. 22, the product page 2200 having a general information tab 2202 for entry of information relating to the product. A product may be selected by entering a product ID into a product ID field 2208, or by entering the product name into a product field 2206. A product lookup button 2207, associated with the product field 2206, opens a dialog box for selection of a product from the database 22. The product price is automatically entered into a price field 2210 with the product is selected. The price may be overridden, by selecting an override price control 2211 and manually entering a new price into the price field 2210.

The general information tab view 2202 also includes order and delivery status information 2212, which may be updated as the order fulfillment progresses and may be accessed to satisfy a customer's status inquiry. The product page 2200 may also include an address tab 2204, producing the page seen in FIG. 23, for entry of a shipping address for the transaction line item, at step 2006 of FIG. 20. The address tab page 2204 is defaulted to the customer's shipping address entered previously at step 1208 (FIG. 12) of the sales order entry process 102. However, it is possible, e.g., with an invoice to purchase multiple products, that different products are to be shipped in a different manner or to a different destination.

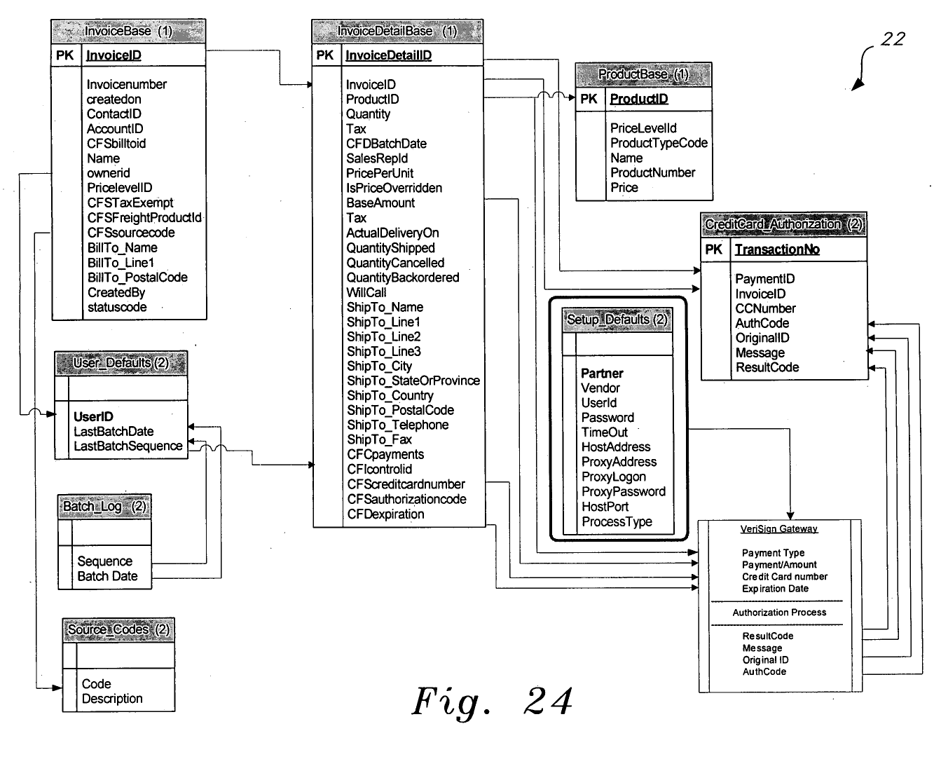

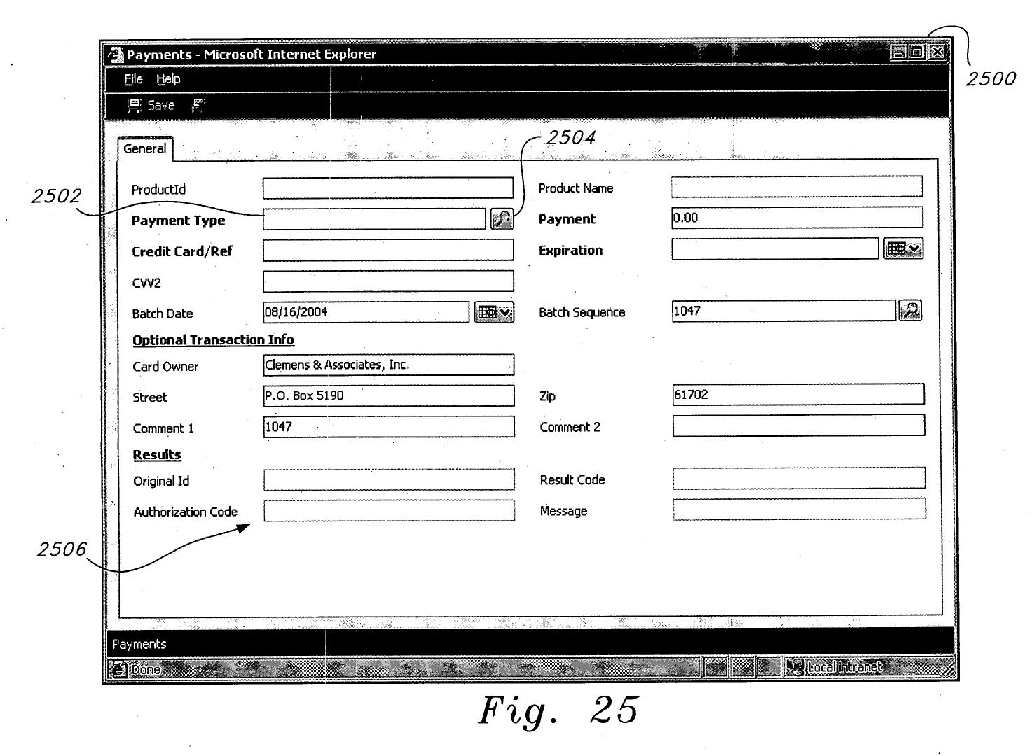

Once product information has been entered for a transaction line item, payment information is entered at step 2008 of FIG. 20. FIG. 24 illustrates a database schema detail for database tables related to the payment process.

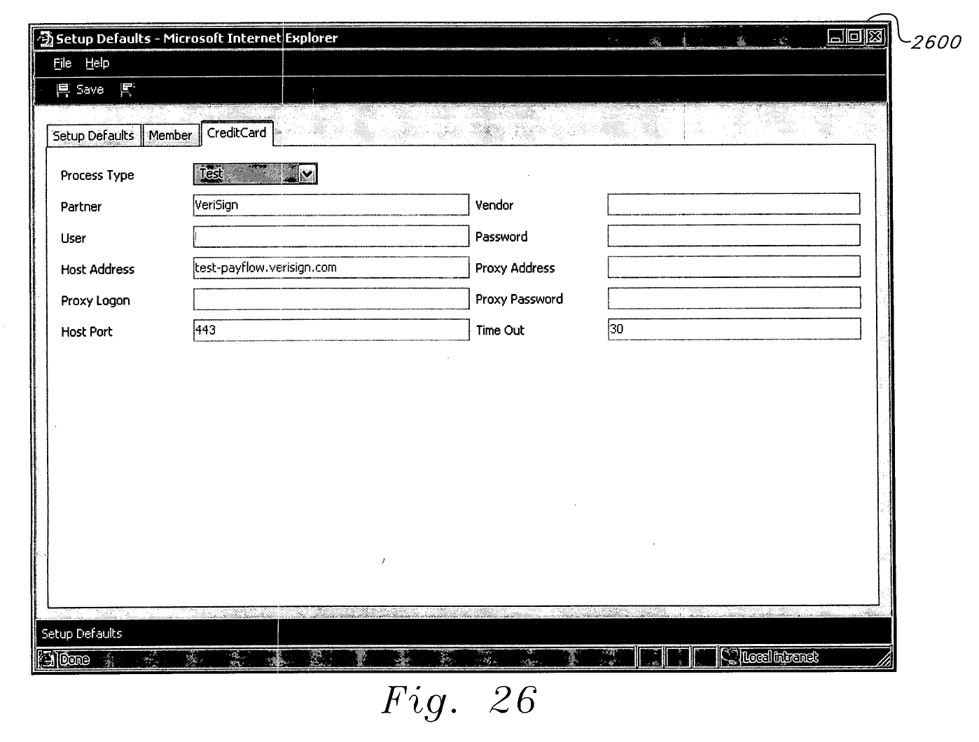

A payment information page 2500, shown in FIG. 25, is presented at step 2008 for the entry of payment information for the product. A payment type is entered in a payment type field 2502. A payment type may be entered by using a payment lookup button 2504 which displays a dialog box listing available payment methods. If the payment method selected requires a credit card, credit card information is entered for authorization and payment at step 2010 (FIG. 20).

An authorization result area 2506 of the payment information view 2500 includes display fields for authorization information, including an authorization code, result code, and a message which indicates the result of the authorization (for example, declined, approved, invalid account).

The electronic credit card authorization process must be enabled by entry of default settings to identify an electronic authorization service, account numbers and access codes, etc. FIG. 26 shows an authorization defaults page 2600 that provides for the entry of electronic authorization service data.

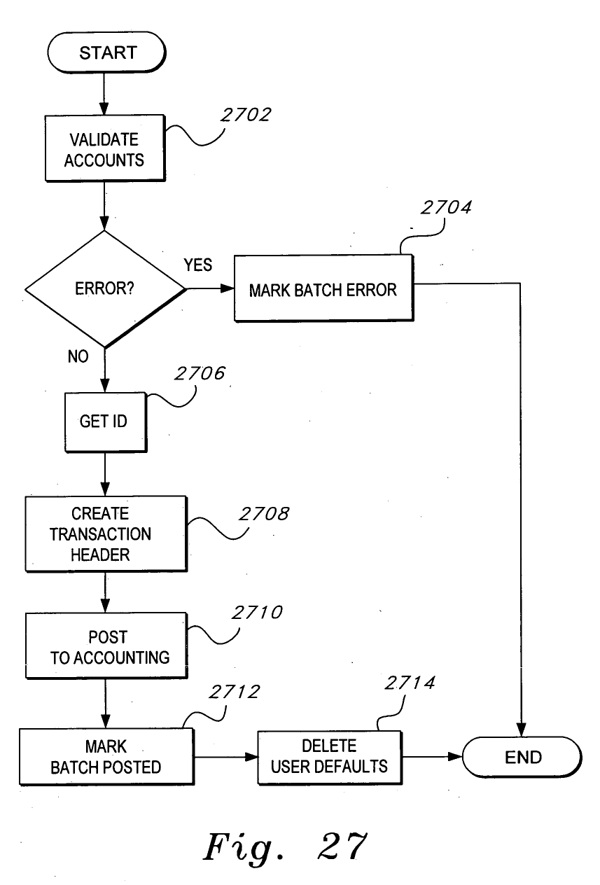

Once sales transactions have been entered, by creation of invoices, the invoices are processed for payment and accounting. Invoices are processed by batch by an external accounting program, such as Microsoft Great Plains or Microsoft Solomon accounting software products. Turning to FIG. 27, a process for posting invoices to an external accounting program is described.

At step 2702, general ledger detail data is read for an invoice batch that is to be posted. An account number within the general ledger detail must match or be validated against an account number known to the external accounting program. If any account numbers do not match, an error is flagged at step 2704 and the posting process terminates. If there are no errors, a journal identifier is retrieved at step 2706 to identify the posting operation. Next, at step 2708, a transaction header is generated. At step 2710, a transaction amount table is generated, and all invoices associated with the batch to be posted are read and added to the transaction amount table. Once the invoice batch has been assembled into the transaction amount table, the transaction header is updated and the data posted to the external accounting program at step 2710. Following posting of the batch to the accounting program, the batch is marked as posted, at step 2712, to prevent re-posting of the same batch. At step 2714, user default data including the batch ID is deleted or reset to prevent re-use of the batch ID of the just-posted batch.

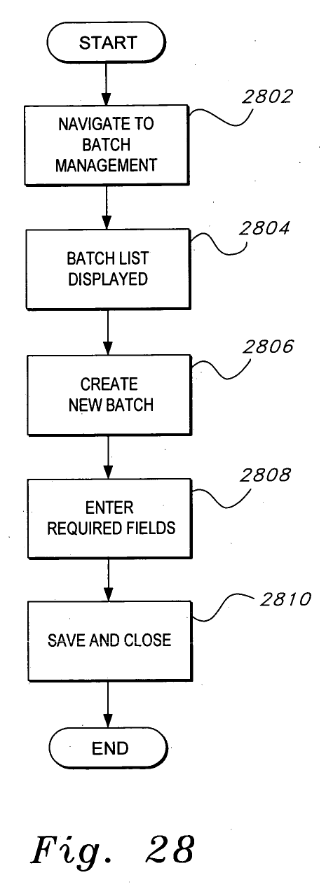

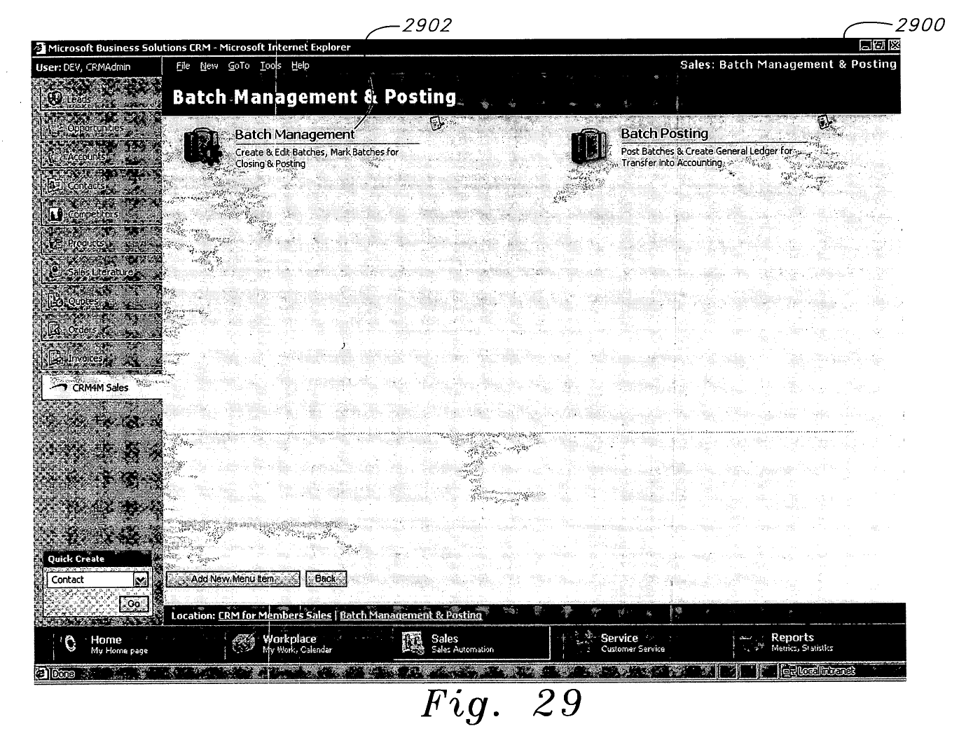

Each invoice created by the invoice transaction lifecycle software 10 is associated with an invoice batch. Thus, the invoice transaction lifecycle software 10 allows for creation and management of invoice batches. Turning to FIG. 28, a process for creating an invoice batch is described. Once the batch creation process is understood, batch management will be understood as including primarily the same operations and user interface views.

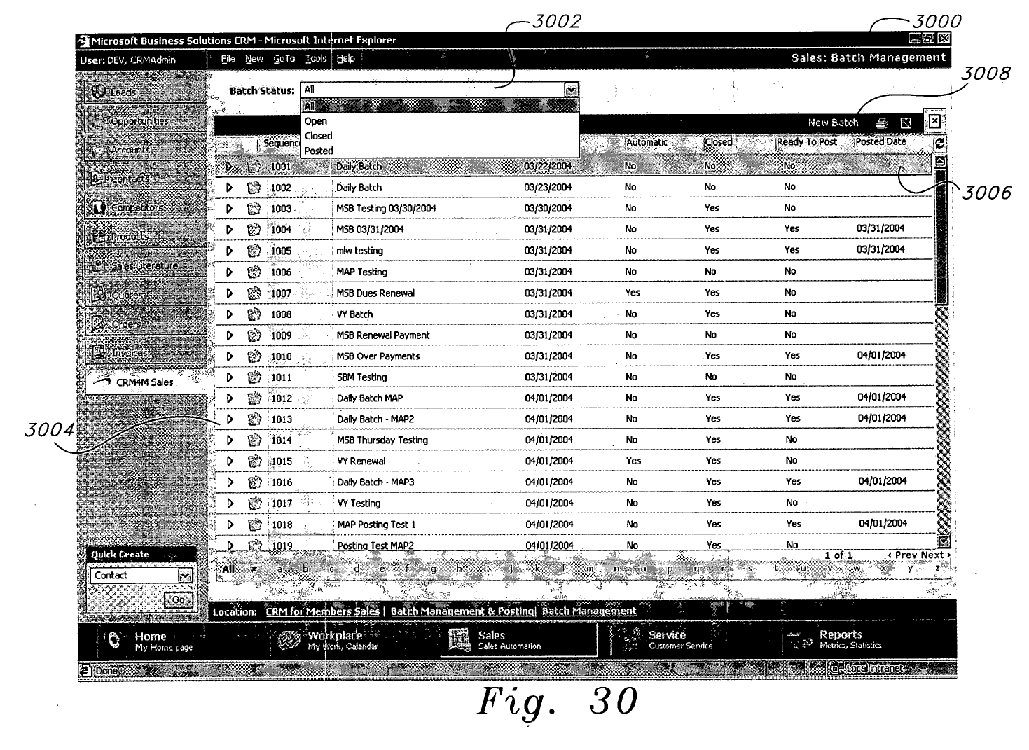

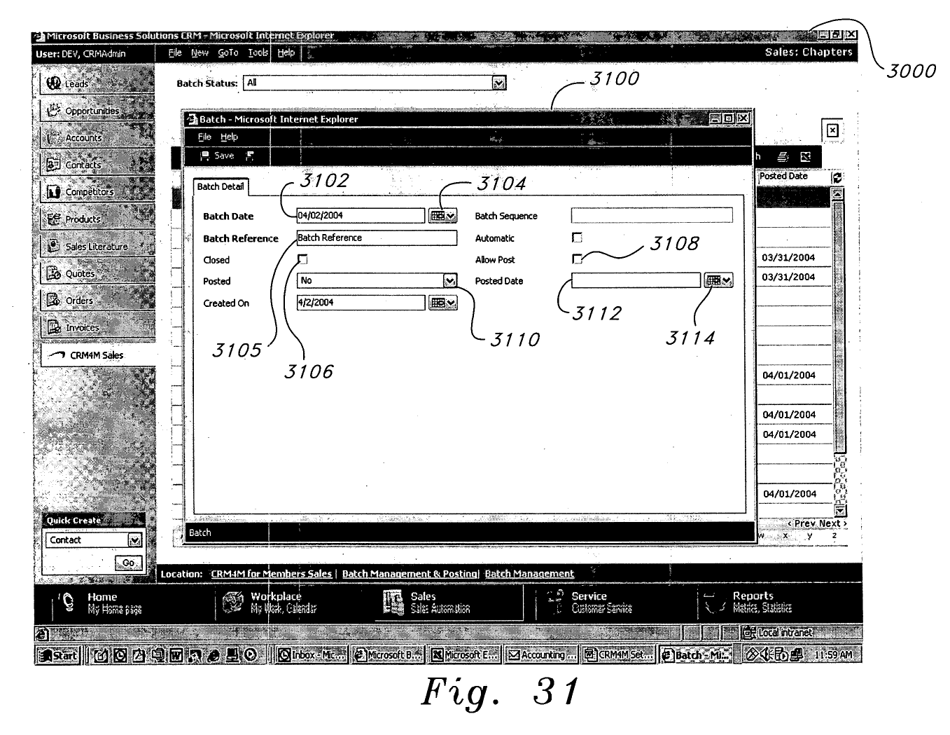

Invoice batch creation begins at step 2802 with navigation to a batch management page 2900, seen in FIG. 29. From this view, batch management and batch posting functions are accessible. Selecting a batch management icon 2902 brings up a batch management page 3000, shown in FIG. 30, displaying a batch list at step 2804. The batch management view 3000 includes a batch list 3004. A filter 3002 allows selection of all batches, or only open, or closed, or posted batches for display in the batch list 3004. For management of existing batches, a highlight bar 3006 is used to select a batch that may be opened or viewed. A new batch button 3008 allows creation of a new batch, at step 2806. Creation of the new batch opens a batch detail dialog box 3100, seen in FIG. 31.

When the new batch is created, a batch date field 3102 is filled, by default, to the current date. The date may be overridden with a calendar entry button, which opens a calendar dialog box for selection of an alternate date. At step 2808, required data fields for the new batch must be entered. A batch reference field 3105 must be filled in with a description of the new batch. A batch sequence number, that uniquely identifies the batch, is automatically assigned in sequence, based on the last created batch or on a setup default value.

Additional controls seen on the batch detail page 3100 include a closed status box 3106, an “allow post” status box 3108, and posting status 3110 and posted date 3112 fields. When a batch is to be closed, the closed status box 3106 is checked. Checking the “allow post” box 3108 allows the batch to be posted for accounting. The batch must be closed before it may be allowed for posting. The posting status field 3110 simply indicates whether or not the batch has been posted. If posted, the posting date field 3112 indicates the date when the batch was posted. A calendar dialog box 3114 associated with the posting date field 3112 allows for modification of the batch's posting date.

Once the new batch is completed, the batch is saved and the batch detail view 3100 closed, at step 2810, completing the batch creation process.

It is to be understood that the present invention is not limited to the embodiment described above, but encompasses any and all embodiments within the scope of the following claims.

1. A computer software product that includes a medium readable by a processor, the medium having stored thereon a set of instructions for modifying and supplementing a customer relationship program to permit multiple users to record all invoice transaction lifecycle events in a database maintained by the customer relationship program executing on a central company server, the set of instructions comprising:
(a) a first sequence of instructions which, when executed by the processor, causes said processor to modify the database to add additional fields to existing tables and to add additional tables to the database for storage of the events;
(b) a second sequence of instructions which, when executed by the processor, causes said processor to produce an invoice web page having at least one form for creating an invoice for a transaction, for receiving user supplied invoice form data, and for storing the invoice in the database;
(c) a third sequence of instructions which, when executed by the processor, causes said processor to produce a payment web page having at least one form for receiving user supplied payment data relating to payment for the transaction, and for recording the payment data in the database; and
(d) a fourth sequence of instructions which, when executed by the processor, causes said processor to generate general ledger account entries and to post the general ledger account entries to an accounting program external to the customer relationship program.

2. The computer software product according to claim 1, wherein said second sequence of instructions includes a fifth sequence of instructions which, when executed by the processor, causes said processor to receive customer identification data and to store the customer identification data in the database.

3. The computer software product according to claim 1, wherein said second sequence of instructions includes a sixth sequence of instructions which, when executed by the processor, causes said processor to produce a transaction form, to receive user supplied transaction form data regarding product identification, pricing, shipping method, and shipping date, and to store the transaction form data in the database.

4. The computer software product according to claim 1, further comprising a seventh sequence of instructions which, when executed by the processor, causes said processor to process a plurality of the invoice forms in an invoice batch.

5. The computer software product according to claim 1, further comprising an eighth sequence of instructions which, when executed by the processor, causes said processor to publish the invoice and payment web pages to a computer network, and to respond to get requests for retrieving information stored in the database and post requests for storing information in the database, the requests being received from a plurality of users through the network.

6. The computer software product according to claim 1, wherein said second sequence of instructions further includes a ninth sequence of instructions which, when executed by the processor, causes said processor to retrieve and apply price schedules for different classes of customers to the invoice form.

7. A computerized method for modifying a customer relationship product to manage invoice transaction lifestyle events on a central database, comprising the steps of:
(a) modifying the database to add additional fields to existing tables and to add additional tables to the database for storage of the events;
(b) producing an invoice web page having at least one form for creating an invoice for a transaction, for receiving user supplied invoice form data, and for storing the invoice in the database;
(c) producing a payment web page having at least one form for receiving user supplied payment data relating to payment for the transaction, and for recording the payment data in the database; and
(d) generating general ledger account entries and posting the general ledger account entries to an accounting program external to the customer relationship program.

8. The computerized method according to claim 7, wherein step (b) further comprises the steps of receiving customer identification data and storing the customer identification data in the database.

9. The computerized method according to claim 7, wherein step (b) further comprises the steps of:
producing a transaction form;
receiving user supplied transaction form data regarding product identification, pricing, shipping method, and shipping date; and
storing the transaction form data in the database.

10. The computerized method according to claim 7, further comprising the step of processing a plurality of the invoice forms in an invoice batch.

11. The computerized method according to claim 7, further comprising the steps of:
publishing the invoice and payment web pages to a computer network; and
responding to get requests for retrieving information stored in the database and post requests for storing information in the database, the requests being received from a plurality of users through the network.

12. The computerized method according to claim 7, wherein step (b) further comprises the steps of retrieving and applying price schedules for different classes of customers to the invoice form.

13. A computer system for recording invoice transaction lifecycle events, comprising:
(a) a computer having a microprocessor, an area of main memory for executing program code under the direction of the microprocessor, and a disk storage device for storing data and program code;
(b) data input means for entering data input cognizable by said microprocessor;
(c) a customer relationship program code stored on the disk storage device, the customer relationship program defining a database; and
(d) an invoice transaction lifecycle program code stored in the disk storage device and executing in main memory under the direction of the microprocessor, the lifecycle program including:
(i) database modification means for modifying the database to add additional fields to existing tables and to add additional tables to the database for storage of the events;
(ii) invoice means for producing an invoice web page having at least one form for creating an invoice for a transaction, for receiving user supplied invoice form data, and for storing the invoice in the database;
(iii) payment means for producing a payment web page having at least one form for receiving user supplied payment data relating to payment for the transaction, and for recording the payment data in the database; and
(iv) posting means for generating general ledger account entries and posting the general ledger account entries to an accounting program external to the customer relationship program.

14. The computer system according to claim 13, wherein said invoice means further includes means for receiving customer identification data and storing the customer identification data in the database.

15. The computer system according to claim 13, wherein said invoice means further includes:
means for producing a transaction form;
means for receiving user supplied transaction form data regarding product identification, pricing, shipping method, and shipping date; and
means for storing the transaction form data in the database.

16. The computer system according to claim 13, further comprising means for processing a plurality of the invoice forms in an invoice batch.

17. The computer system according to claim 13, further comprising a data communications means connected to said computer adapted for connection to a computer network, the lifecycle program further including:
means for publishing the invoice and payment web pages to the computer network; and
means for responding to get requests for retrieving information stored in the database and to post requests for storing information in the database, the requests being received from a plurality of users through the network.

18. The computer system according to claim 13, wherein said invoice means further includes for retrieving and applying price schedules for different classes of customers to the invoice form.
